(19) United States
(12) Patent Application Publication
(10) Pub. No.: US 2019/0263001 A1
(43) Pub. Date: Aug. 29, 2019

(54) GRIP FORCE SETTING SYSTEM, GRIP FORCE SETTING METHOD, AND GRIP FORCE ESTIMATING SYSTEM

(71) Applicant: KABUSHIKI KAISHA YASKAWA DENKI, Kitakyushu-shi (JP)

(72) Inventors: Haruhiko KOIKE, Kitakyushu-shi (JP); Satoru SUGISAKI, Kitakyushu-shi (JP); Koichi KIRIHARA, Kitakyushu-shi (JP); Shigeo MATSUSHITA, Kitakyushu-shi (JP); Kanji WATANABE, Kitakyushu-shi (JP)

(73) Assignee: KABUSHIKI KAISHA YASKAWA DENKI, Kitakyushu-shi (JP)

(21) Appl. No.: 16/412,437

(22) Filed: May 15, 2019

Related U.S. Application Data
(63) Continuation of application No. PCT/JP2016/084176, filed on Nov. 17, 2016.

(51) Int. Cl. B25J 13/08; B25J 15/10

(52) U.S. Cl. CPC B25J 13/088; B25J 15/10; B25J 13/087

(57) ABSTRACT

A grip force setting system includes a gripper, a detector, and circuitry. The gripper is to grip a gripping target object. The detector is to detect a deformation amount of the gripping target object in a state in which the gripper grips the gripping target object with a test grip force. The circuitry is to determine an operation grip force of the gripper based on a specific deformation characteristic value calculated based on a ratio of the deformation amount to the test grip force.

### CROSS-REFERENCE TO RELATED APPLICATION

The present application is a continuation application of International Application No. PCT/JP2016/084176, filed Nov. 17, 2016. The contents of this application are incorporated herein by reference in their entirety.

### BACKGROUND

### Technical Field

An embodiment described herein relates to a grip force setting system, a grip force setting method, and a grip force estimating system.

### Related Art

Japanese Patent Application Laid-open No. 2015-85439 describes a gripping apparatus configured to be capable of gripping a plurality of different kinds of objects to be gripped having different softness indexes.

### SUMMARY

According to one aspect of the present invention, a grip force setting system includes a gripper, a detector, and circuitry. The gripper is to grip a gripping target object. The detector is to detect a deformation amount of the gripping target object in a state in which the gripper grips the gripping target object with a test grip force. The circuitry is to determine an operation grip force of the gripper based on a specific deformation characteristic value calculated based on a ratio of the deformation amount to the test grip force.

According to another aspect of the present invention, a grip force setting method includes gripping a gripping target object via a gripper. A deformation amount of the gripping target object is detected in a state in which the gripper grips the gripping target object with a test grip force. An operation grip force of a gripper is determined based on a specific deformation characteristic value calculated based on a ratio of the deformation amount to the test grip value.

According to further aspect of the present invention, a grip force estimating system includes a detector and circuitry. The detector is to detect a deformation amount of a gripping target object in a state in which a gripper grips the gripping target object with a test grip force. The circuitry is to estimate an estimated grip force based on the deformation amount when the gripper grips the gripping target object.

### BRIEF DESCRIPTION OF DRAWINGS

A more complete appreciation of the invention and many of the attendant advantages thereof will be readily obtained as the same becomes better understood by reference to the following detailed description when considered in connection with the accompanying drawings.

FIG. 1 is a view showing an example of a schematic system block configuration of a grip force setting system according to an embodiment;

FIG. 2 is a view showing an appearance of an entire gripper as viewed from an imaging field of view of a camera;

FIG. 3 is a view showing an example of shape change of a gripping target object that is generated when the gripping target object is gripped by a gripper;

FIG. 4 is a view showing an example of a graph showing gripping characteristics of a test result of an individual gripping target object which is a food of a flexible object;

FIG. 5 is an example of a flowchart showing a processing procedure executed by a CPU of a controller to realize grip force setting processing;

FIG. 6 is an example of a flowchart showing the processing procedure executed by the CPU of the controller to realize the grip force setting processing;

FIG. 7 is a view showing a case where the gripping target object has deformation directivity in a direction orthogonal to a gripping direction;

FIG. 8A is a side view of a three-finger gripper;

FIG. 8B is a plan view of the three-finger gripper;

FIG. 9 is a view for describing a detection position of a deformation amount when the three-finger gripper is used;

FIG. 10A is a view for describing a detection position of the deformation amount when a distance sensor is used;

FIG. 10B is a view for describing a detection position of the deformation amount when the distance sensor is used;

FIG. 11 is a view showing an example of a graph showing deformation characteristics used in a grip force estimating system; and

FIG. 12 is a block diagram showing an example of a hardware configuration of an image processing apparatus and a controller.

### DETAILED DESCRIPTION

The embodiments will now be described with reference to the accompanying drawings, wherein like reference numerals designate corresponding or identical elements throughout the various drawings.

### 1. SCHEMATIC CONFIGURATION OF GRIP FORCE SETTING SYSTEM

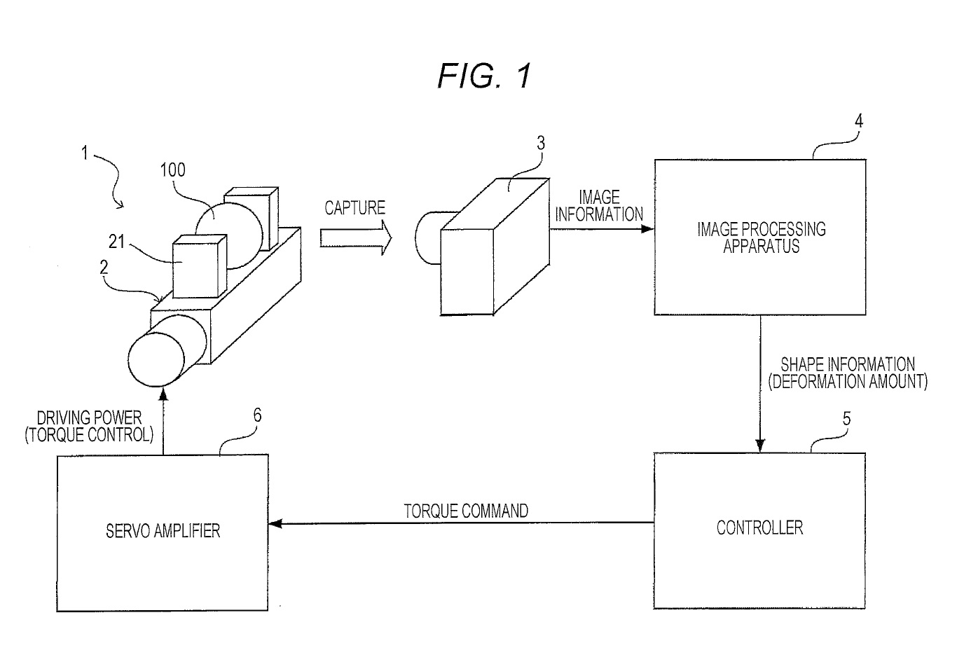

FIG. 1 shows an example of a schematic system block configuration of a grip force setting system according to the present embodiment. In the grip force setting system, for actual operation of gripping and transferring a gripping target object which has predetermined gripping characteristics (described later), by a gripper which is a gripper of a production machine or the like, a suitable operation grip force to be applied is set corresponding to the gripping characteristics. In FIG. 1, a grip force setting system 1 has a gripper 2, a camera 3, an image processing apparatus 4, a controller 5, and a servo amplifier 6.

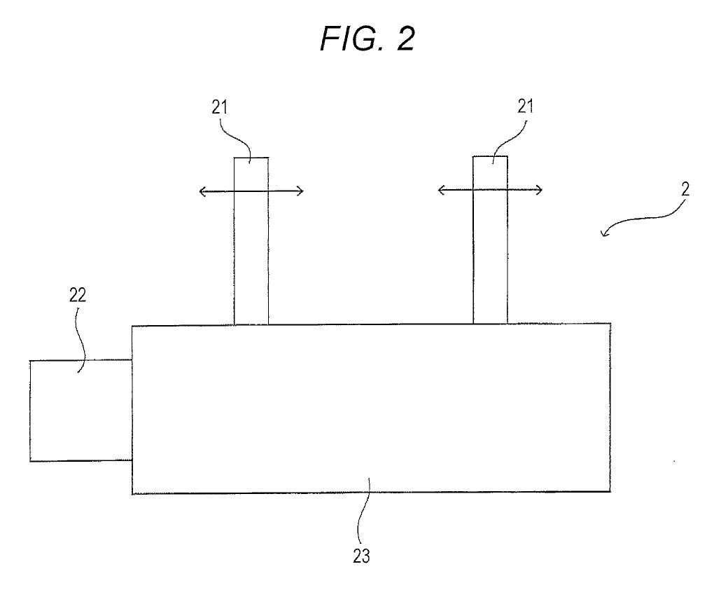

In this example, the gripper 2 (gripper) uses a rotary motor as a drive source and serves as an actuator which causes two gripping claws 21 arranged in parallel to perform approaching operation and separating operation, thereby holding and releasing the gripping target object 100. In the present embodiment, it is assumed that the gripper 2 is fixed to, for example, an arm tip portion of an arm manipulator (not shown), and can also lift and transfer the gripping target object 100 while gripping the gripping target object 100. The detailed configuration of the gripper 2 will be described later with reference to FIG. 2.

In this example, the camera 3 is an optical sensor that optically acquires two-dimensional image information. The camera 3 is fixedly installed so that the entire external appearance of the gripping target object 100 gripped by the gripper 2 can be captured at the same orientation and intervals at all times.

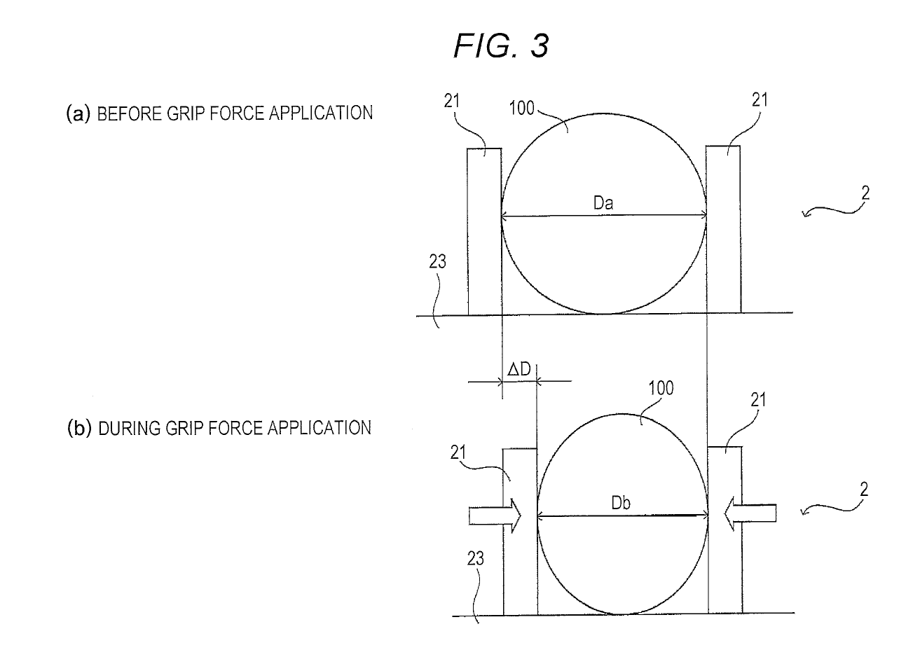

Based on the image information acquired by the camera 3, the image processing apparatus 4 detects a deformation amount of the gripping target object 100 gripped by the gripper 2 as shape information. The details of this deformation amount will be described later with reference to FIG. 3.

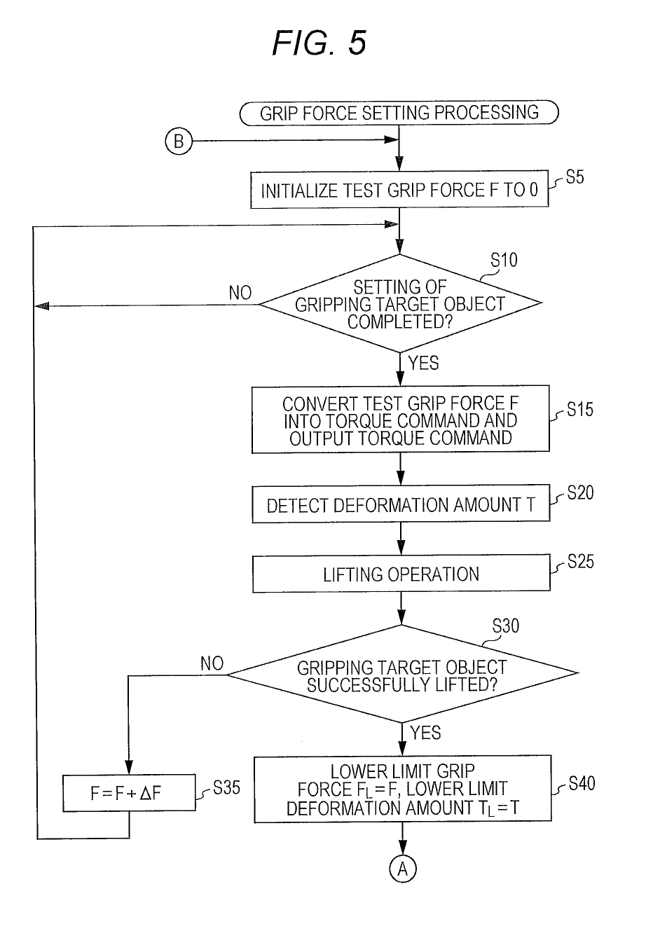

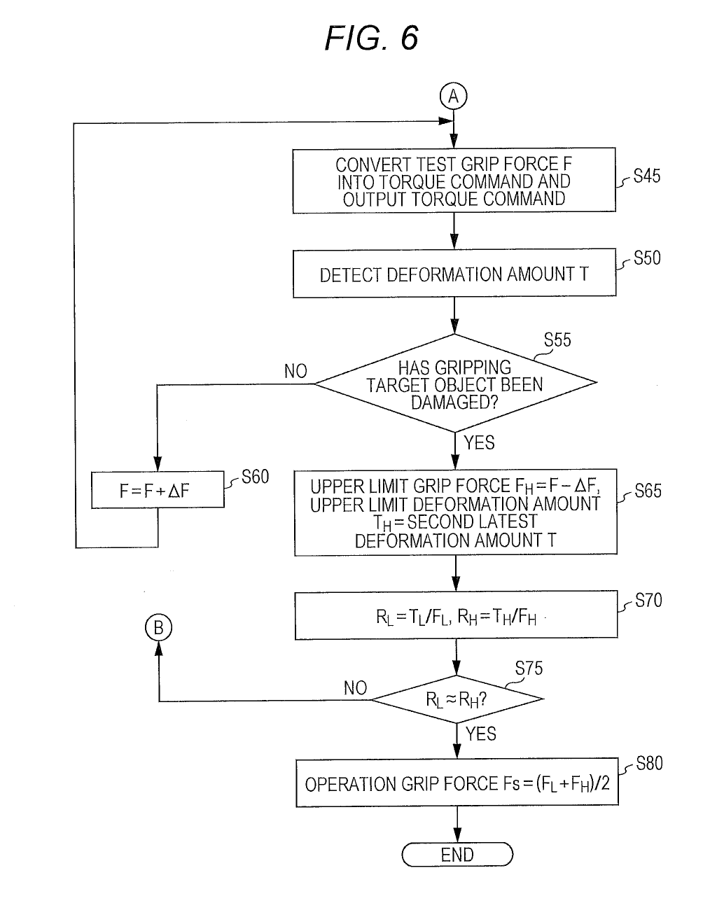

The controller 5 outputs an operation command (a torque command of the motor conforming to a test grip force to be described later) to the gripper 2 in accordance with a procedure of a grip force setting processing to be described later, and calculates the operation grip force to be finally set based on the shape information (deformation amount) detected by the image processing apparatus 4. The details of the grip force setting processing will be described later with reference to FIGS. 5 and 6.

The servo amplifier 6 (motor controller) controls (torque control) driving power to be fed to the motor of the gripper 2 based on the operation command (torque command) output from the controller 5.

The camera 3 and the image processing apparatus 4 correspond to a detector recited in the claims, and the controller 5 corresponds to a circuitry recited in the claims. In addition, the controller 5 corresponds to a circuitry to set an operation grip force of a gripper with respect to the gripping target object 100 within a grip force range in which a specific deformation characteristic value calculated by a ratio of the deformation amount to a test grip force recited in the claims is common among individuals of the gripping target object 100.

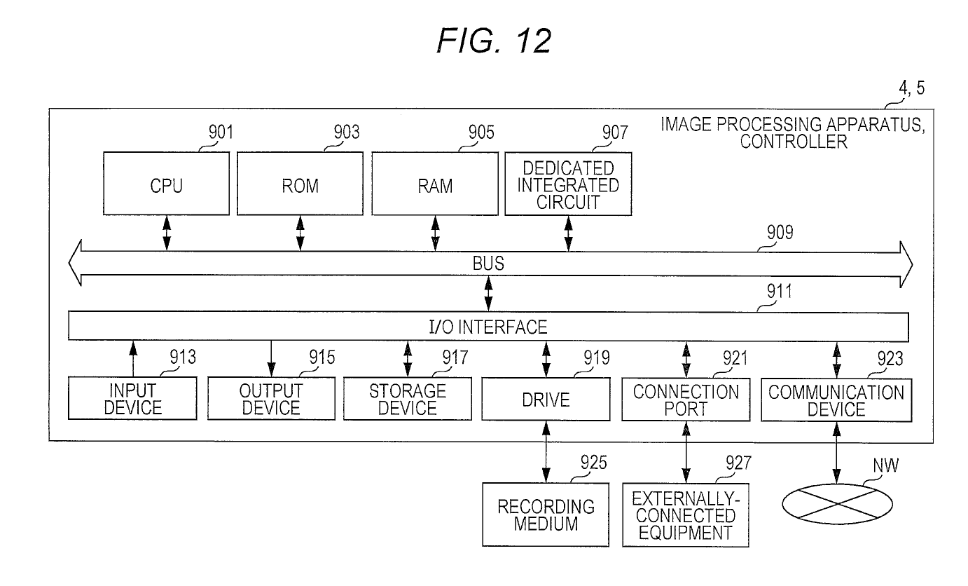

Meanwhile, processes and the like in the image processing apparatus 4, the controller 5, the servo amplifier 6 and the like are not limited to the example of allotment of these processes, but, for example, they may be processed in a smaller number of processing parts (for example, one processing part) or in processing parts furthermore segmentalized. The image processing apparatus 4 and the controller 5 may be implemented by a program executed by a CPU 901 (see FIG. 12) to be described later, or a part or the whole thereof may be implemented with an actual device such as ASIC, FPGA or another electric circuit.

In the grip force setting system 1 configured as described above, the controller 5 executes the procedure of the grip force setting processing to be described later, so that the gripper 2 operates so as to repeatedly grip and transfer the gripping target object 100, which is a specimen. At this time, with respect to the gripping target objects 100 having the same gripping characteristics (described later), a test grip force (test grip force) generated when the gripper 2 individually grips the gripping target objects 100, that is, a pressure contact force generated when the gripping target object 100 is held between two gripping claws of the gripper 2 is changed to be increased and decreased. Presence or absence of falling of the gripping target object 100 during lifting operation and a damage state of the gripping target object 100 are repeatedly confirmed, so that a suitable operation grip force (operation grip force) to be applied at the actual operation of a production machine is set. In the actual operation after once the suitable operation grip force is set, the controller 5 only needs to output the operation command to the servo amplifier 6 with the operation grip force and perform torque control of the motor, so that the camera 3 and the image processing apparatus 4 become unnecessary and can be removed from the system.

In the present embodiment, a case where the grip force setting system 1 sets the operation grip force for gripping and transferring a flexible object as the gripping target object 100 by the gripper 2 will be described. Here, the flexible object in the present embodiment means an object having such flexibility that its shape can be easily deformed by general human's normal grip strength, and examples of the flexible object include foods such as rice balls and sandwiches and ingredients such as shell eggs.

### 2. DETAILED CONFIGURATION OF GRIPPER

FIG. 2 shows an appearance of the entire gripper 2 as viewed from an imaging field of view of the camera 3. In FIG. 2, the gripper 2 has a motor 22, a gripper body 23, and the two gripping claws 21.

As described above, in the example of the present embodiment, the motor 22 uses a rotary motor and is fixed to a side surface of the gripper body 23 which is a substantially rectangular parallelepiped casing. A shaft rotation output of the motor 22 is converted into a linear motion output of the two gripping claws 21 via a drive mechanism constituted of a ball screw, a pinion gear, a rack gear, a linear guide and the like (not shown) provided inside the gripper body 23. By switching the forward rotation and the reverse rotation of the motor 22, the two gripping claws 21 with their respective contact surfaces facing each other are operated so as to switch between approaching operation and separating operation mutually. The grip force between the two gripping claws 21 is controlled by controlling the torque of the motor 22. In the functioning as described above, the gripper 2 can perform linear gripping operation and releasing operation with respect to the gripping target object 100 disposed between the two gripping claws 21.

It is desirable that the gripper 2 be configured to be capable of outputting relatively low grip force with high accuracy. Specifically, it is preferable to use a servo motor, which can output and control a low torque with high accuracy, as the motor 22. In order to smoothly and linearly move the gripping claw 21, it is preferable to use a low friction and high lead ball screw, a pinion gear and a rack gear capable of being meshed with rotation with low friction, and a linear guide mechanism of low friction. Further, it is preferable to use the gripping claw 21 whose shape, material, and configuration that can stably grip the gripping target object 100 even with relatively low grip force by, for example, securing a sufficient contact area with respect to the gripping target object 100. Furthermore, it is preferable to properly consider design of a mechanical configuration in consideration of, for example, a position of a center of gravity of the entire gripper 2 and assembly and adjustment of each component.

### 3. FEATURES OF THE PRESENT EMBODIMENT

Generally, when the gripping target objects 100 having predetermined gripping characteristics have uniformly the same shape and size, even if the gripping claw 21 of the gripper 2 is driven and controlled by position control, the gripping target object 100 is stably gripped without being damaged and easily transferred. However, even if the gripping target objects 100 have the same gripping characteristics, in a case where the gripping target objects 100 have variations in shape and size for each individual, when the position of the gripper 2 is controlled, it is not possible to deal with such variations in shape and size, so that it is likely to damage the gripping target object 100 or it tends to be difficult to lift the gripping target object 100.

On the other hand, in recent years, there has been a demand for a production machine system that grips and transfers, as the gripping target object 100, flexible objects that are frequently found in foods and the like. Thus, particularly when food is the gripping target object 100, in addition to the above-mentioned individual differences, a difference between an upper limit grip force for not damaging and a lower limit grip force required for lifting is often small. Therefore, it has been difficult to adjust and control the grip force to be applied to the gripping target object 100 by the gripper 2.

On the other hand, in the present embodiment, a grip test is repeated while changing a test grip force (corresponding to a test grip force) to increase and decrease the test grip force, whereby an operation grip force to be applied to the gripping target object 100 by the gripper 2 during actual operation is set. The grip force setting system 1 used at this time has the camera 3, the image processing apparatus 4, and the controller 5. The camera 3 and the image processing apparatus 4 detect the deformation amount of the gripping target object 100 when the gripper 2 grips the gripping target object 100 with the test grip force. The controller 5 sets the operation grip force of the gripper 2 with respect to the gripping target object 100 based on the later-described specific deformation characteristic value calculated based on a ratio of the deformation amount to the test grip force.

Here, in the gripping target objects 100 having the same gripping characteristics, there is a grip force region indicating a common specific deformation characteristic value regardless of individual differences such as shape and size. When the controller 5 sets a common operation grip force within the grip force region, even in the gripping target object 100 in which the difference between the upper limit grip force and the lower limit grip force is small as in foods and the like, the gripping target object 100 can be stably gripped and transferred without being damaged while flexibly coping with variations in shape and size for each individual. Hereinafter, a method of setting the operation grip force thus will be described.

### 4. METHOD OF SETTING OPERATION GRIP FORCE

FIG. 3 shows an example of shape change of the gripping target object 100 that is generated when the gripping target object 100 is gripped by the gripper 2. The upper side (a) of FIG. 3 shows the state before the grip force is applied, and the lower side (b) of FIG. 3 shows the state after the grip force is applied. In FIG. 3, the motor 22 and the gripper body 23 are omitted from the imaging field of view of the camera 3 similar to the one shown in FIG. 2, and only the two gripping claws 21 and the periphery of the gripping target object 100, which is located between the two gripping claws 21 are illustrated.

In the illustrated example, an original shape of the gripping target object 100 is a sphere having a diameter Da, and a predetermined grip force is applied in the left and right direction in the figure, whereby the diameter is compressed and deformed to Db (<Da) only in a grip force-applied direction. In the example of the present embodiment, when a deviation dimension between the original dimension Da in the grip force-applied direction before the application of the grip force and the deformed dimension Db in the grip force-applied direction after the application of the grip force is ΔD (absolute shape change amount), the image processing apparatus 4 outputs, as the deformation amount (shape information), a ratio ΔD/Da (so-called distortion) of the deviation dimension ΔD to the original dimension Da. Specifically, the camera 3 captures the shape change of the entire gripping target object 100 before and after the application of the grip force, and outputs two-dimensional image information. The image processing apparatus 4 calculates the deformation amount from a change in outline of the gripping target object 100 in this image information.

Here, depending on the material and internal structure of elements constituting the gripping target object 100, the deformation amount to be generated may have geometric directivity in some cases. That is, even if the same grip force is applied to the same gripping target object 100, the deformation amount to be generated changes depending on the orientation of the gripping target object 100 and the grip force-applied direction. In the grip force setting system 1 of the present embodiment, the gripping target objects 100 of the same type are gripped with the same grip orientation in the same grip force-applied direction, so that generation directivity of the deformation amount is uniformly defined. In the present embodiment, a relationship characteristic between the grip force and the deformation amount common to the same type of the gripping target objects 100 including such a case defined by a specific deformation directivity is referred to as the gripping characteristic.

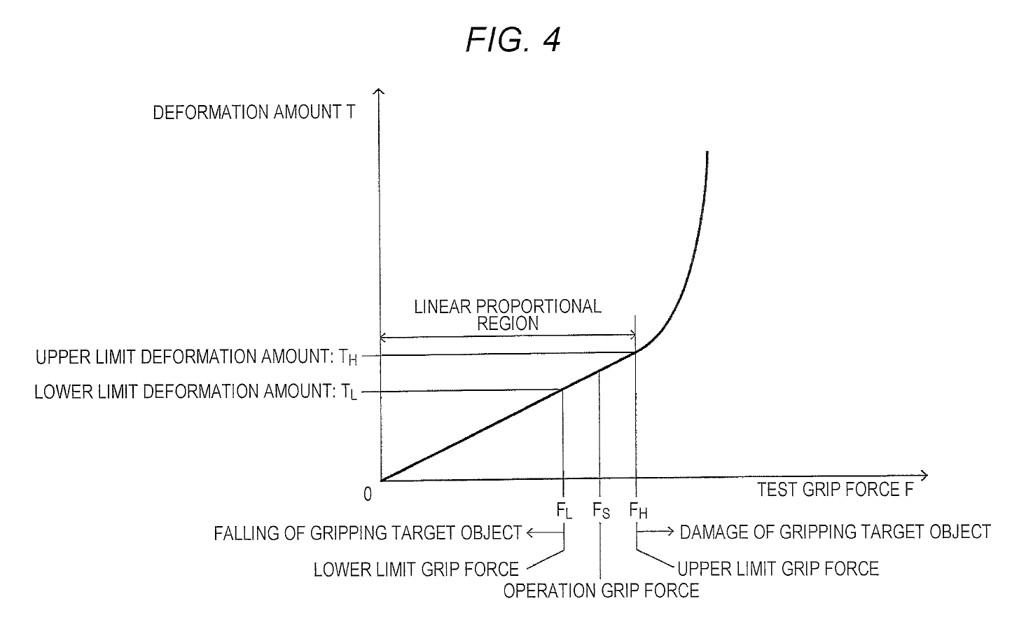

FIG. 4 shows an example of a graph showing the gripping characteristics of a test result of the individual gripping target object 100, which is a food of a flexible object. In FIG. 4, the horizontal axis corresponds to the test grip force F applied to the gripping target object 100, and the vertical axis corresponds to a deformation amount T (distortion) generated in the gripping target object 100. In the example of the gripping characteristics shown in the graph of FIG. 4, a linear proportional region (that is, a region where the graph draws a straight line with a constant slope) is formed. In the linear proportional region, the specific deformation characteristic value which is a ratio T/F of the deformation amount T to the test grip force F is substantially constant within a range in which the test grip force F is 0 to F_{H}. The deformation amount T abruptly increases in a region where the test grip force F is larger than F_{H}.

As described above, the linear proportional region as described above partially exists in the gripping characteristics of a general gripping target object 100 including a flexible object, and within the linear proportional region, the gripping target object 100 exhibits elastic properties (reversible deformation properties) with a spring coefficient. In the linear proportional region, it is known that the same type of the gripping target objects 100 indicate a common specific deformation characteristic value regardless of individual differences such as shape and size.

Further, it is known that both an upper limit grip force F_{H}, which is a maximum grip force that does not damage the gripping target object 100, and a lower limit grip force F_{L}, which is a minimum grip force that can hold the gripping target object 100, are present in the linear proportional region. Therefore, the upper limit grip force F_{H} and the lower limit grip force F_{L} are confirmed, and the operation grip force is set therebetween, so that it is possible to reliably and suitably grip and transfer the gripping target objects 100 of the same type having the same gripping characteristics regardless of individual differences such as the shape and size.

In the example of the present embodiment, an operator of the grip force setting system 1 visually confirms and determines whether or not the gripping target object 100 is damaged as a reference of the upper limit grip force F_{H} and whether or not the gripping target object 100 can be lifted as a reference of the lower limit grip force F_{L}.

### 5. CONTROL FLOW OF GRIP FORCE SETTING PROCESSING

FIGS. 5 and 6 show an example of a flowchart showing a processing procedure executed by the CPU 901 (arithmetic unit; see FIG. 12 described later) of the controller 5 to realize the grip force setting processing according to the present embodiment described above. The processing shown in this flow is started from the start of the grip force setting system 1.

First in step S5, the CPU 901 initializes the test grip force F as a variable to 0.

Next, in step S10, the CPU 901 loops back and enters a standby state until the operation of properly setting the gripping target object 100 to the gripper 2 is completed. For example, it may be determined whether or not a start command has been input from an operator via an operation unit (particularly not shown).

Next, in step S15, the CPU 901 converts the test grip force F at this point of time into a torque command and outputs the torque command to the servo amplifier 6. As a result, the driving power to be supplied to the motor 22 changes, and the gripper 2 grips the gripping target object 100 with the grip force corresponding to the test grip force F.

Next, in step S20, the CPU 901 acquires image information from the image processing apparatus 4 and detects the deformation amount T of the gripping target object 100 at this point of time.

Next, in step S25, the CPU 901 sends a command to an arm manipulator (particularly not shown) to cause the arm manipulator to perform an operation of lifting the gripper 2 together with the gripping target object 100.

Next, in step S30, the CPU 901 determines whether or not the gripper 2 has been able to stably lift the gripping target object 100 by the lifting operation in step S25. As described above, this determination is actually made by operator's visual confirmation, and it may be determined based on contents of determination input from the operator via the operation unit (particularly not shown). Alternatively, this determination may be made by the image processing apparatus 4 based on the image information captured by the camera 3, or a contact sensor or the like is provided below the gripper 2, and it may be determined based on detection of falling of the gripping target object 100 (not shown). If the gripping target object 100 has not been successfully lifted, the determination is not satisfied, and the processing proceeds to step S35.

In step S35, the CPU 901 adds a relatively small step value ΔF to the test grip force F, returns to step S10 and repeats the same procedure.

On the other hand, when the gripping target object 100 is successfully lifted in the determination of step S30, the determination is satisfied, and the processing proceeds to step S40.

In step S40, the CPU 901 sets the lower limit grip force F_{L} with the test grip force F at this point of time and sets a lower limit deformation amount T_{L} with the latest deformation amount T at this point of time.

Next, in step S45, the CPU 901 converts the test grip force F at this point of time into a torque command and outputs the torque command to the servo amplifier 6 as in step S15.

Next, in step S50, the CPU 901 acquires image information from the image processing apparatus 4 and detects the deformation amount T of the gripping target object 100 at this point of time as in step S20.

Next, in step S55, and the CPU 901 determines whether or not the gripper 2 has damaged the gripping target object 100. As described above, this determination is actually made by operator's visual confirmation, and it may be determined based on contents of determination input from the operator via the operation unit (particularly not shown). At this time, presence or absence of damage may be determined based on, for example, whether or not the shape of the gripping target object 100 has been deformed to such an extent that the gripping target object 100 cannot be reversibly returned, or whether or not clear scratches and cracks have occurred, for example, when the eggshell is damaged. If the gripping target object 100 is not damaged, the determination is not satisfied, and the processing proceeds to step S60.

In step S60, the CPU 901 adds the relatively small step value ΔF to the test grip force F, returns to step S45 and repeats the same procedure.

On the other hand, when the gripping target object 100 has been damaged in the determination of step S55, the determination is satisfied, and the processing proceeds to step S65.

In step S65, the CPU 901 sets the upper limit grip force F_{H} with a value obtained by subtracting ΔF from the test grip force F at this point of time and sets an upper limit deformation amount T_{H} with the second latest deformation amount T at this point of time.

Next, in step S70, the CPU 901 calculates a lower limit specific deformation characteristic value R_{L} with a ratio of the lower limit deformation amount I_{L} to the lower limit grip force F_{L} set in step S40, and calculates an upper limit specific deformation characteristic value R_{H} with a ratio of the upper limit deformation amount T_{H} to the upper limit grip force F_{H} set in step S65.

Next, in step S70, the CPU 901 determines whether or not the lower limit specific deformation characteristic value R_{L} and the upper limit specific deformation characteristic value R_{H} calculated in step S70 substantially coincide. When the lower limit specific deformation characteristic value R_{L} and the upper limit specific deformation characteristic value R_{H} are different by more than a certain amount, the determination is not satisfied, and the processing returns to step S5 to repeat the same procedure. In other words, it is regarded that the test grip force F deviates from the linear proportional region and the grip force setting processing for the gripping target object 100 fails, and the grip force setting processing is restarted from the beginning.

On the other hand, when the lower limit specific deformation characteristic value R_{L} and the upper limit specific deformation characteristic value R_{H} substantially coincide, the determination is satisfied, and the processing proceeds to step S80.

In step S80, the CPU 901 sets the operation grip force Fs with an average value of the lower limit specific deformation characteristic value R_{L} and the upper limit specific deformation characteristic value R_{H}, and ends this flow.

### 6. Effects of the Present Embodiment

As described above, according to the grip force setting system 1 of the present embodiment, the grip test is repeated while changing the test grip force to increase and decrease the test grip force, whereby the operation grip force to be applied to the gripping target object 100 by the gripper 2 during actual operation is set. The grip force setting system 1 has the camera 3, the image processing apparatus 4, and the controller 5. The camera 3 and the image processing apparatus 4 detect the deformation amount of the gripping target object 100 when the gripper 2 grips the gripping target object 100 with the test grip force. The controller 5 sets the operation grip force of the gripper 2 with respect to the gripping target object 100 based on the specific deformation characteristic value calculated based on the ratio of the deformation amount to the test grip force.

Here, in the gripping target objects 100 having the same gripping characteristics, there is a grip force region indicating a common specific deformation characteristic value regardless of individual differences such as shape and size. When the controller 5 sets the common operation grip force within the grip force region, even in the gripping target object 100 in which the difference between the upper limit grip force and the lower limit grip force is small as in foods and the like, the gripping target object 100 can be stably gripped and transferred without being damaged while flexibly coping with variations in shape and size for each individual in the actual operation. As a result, it is possible to improve a gripping function corresponding to flexibility of the gripping target object 100.

In the present embodiment, in particular, the controller 5 sets the operation grip force within the linear proportional region of the test grip force and the deformation amount at which the specific deformation characteristic value is substantially constant. The grip force region indicating the above-mentioned specific deformation characteristic value common between individuals is present within the linear proportional region of the test grip force and the deformation amount at which the specific deformation characteristic value is substantially constant in each individual. By setting the operation grip force within such a linear proportional region, it is possible to set a suitable operation grip force in actual operation.

In the present embodiment, the case where the linear proportional region is formed within the range in which the test grip force F is 0 to the upper limit grip force F_{R} has been described as shown in FIG. 4. However, depending on the configuration of the gripping target object, the linear proportional region may be formed within a range of 0<F<F_{R}, for example. In this case, a rate of change of the deformation amount per unit test grip force (that is, the slope of a linear graph) is replaced with the specific deformation characteristic value, whereby it can be interpreted that the specific deformation characteristic value is substantially constant within the linear proportional region (not shown).

In the present embodiment, in particular, the controller 5 sets the maximum upper limit grip force that the gripper 2 does not damage the gripping target object 100 and the minimum lower limit grip force that the gripper 2 can lift the gripping target object 100, and the operation grip force is set between the upper limit grip force and the lower limit grip force. As described above, the upper limit grip force and the lower limit grip force are further confirmed within the above-mentioned linear proportional region, and the operation grip force is set therebetween, so that more suitable and reliable setting can be performed in order to execute the gripping operation and the transfer operation. Further, in the present embodiment, the operation grip force is set based on the average value of the upper limit grip force and the lower limit grip force. However, the present invention is not limited to this example. For example, when there is sufficient margin for the difference between the upper limit grip force and the lower limit grip force, the operation grip force may be set with a value obtained by multiplying either one of the upper limit grip force and the lower limit grip force by a predetermined margin coefficient. For example, when emphasis is placed on preventing damage to the gripping target object 100, the operation grip force may be set with a value obtained by multiplying the upper limit grip force by a margin coefficient less than 1. On the other hand, when emphasis is placed on the reliable lifting operation of the gripping target object 100, the operation grip force may be set with a value obtained by multiplying the lower limit grip force by a margin coefficient more than 1.

In the present embodiment, in particular, a functional unit (the camera 3 and the image processing apparatus 4) that detects the deformation amount of the gripping target object 100 has an optical sensor (the camera 3) that detects the shape of the gripping target object 100 by an optical method. As a result, the deformation amount of the gripping target object 100 can be detected with high accuracy in a non-contact manner, and it is useful particularly when a food for which hygiene is to be emphasized is the gripping target object 100.

In the present embodiment, in particular, since the optical sensor is the camera 3 which captures the entire shape of the gripping target object 100, it is possible to detect the deformation amount flexibly corresponding to fluctuations in the position where the gripping target object 100 is gripped and variations in shape and size for each individual.

In the present embodiment, in particular, the camera 3 and the image processing apparatus 4 detect the deformation amount with a ratio (so-called distortion) of the absolute shape change amount to the size of the entire gripping target object 100, whereby in particular it is possible to set a suitable operation grip force that cancels variations in size for each individual of the gripping target object 100. The deviation dimension ΔD itself, which is the absolute shape change amount, may be detected as the deformation amount.

In the present embodiment, in particular, the camera 3 and the image processing apparatus 4 detect the deformation amount in a direction equal to a gripping direction in which the gripper 2 applies the test grip force. As a result, it is possible to improve detection accuracy (setting precision of the operation grip force) of the effective deformation amount with respect to the gripping target object 100 having gripping characteristics that tend to be deformed particularly in the gripping direction (are less likely to be deformed in a direction different from the gripping direction).

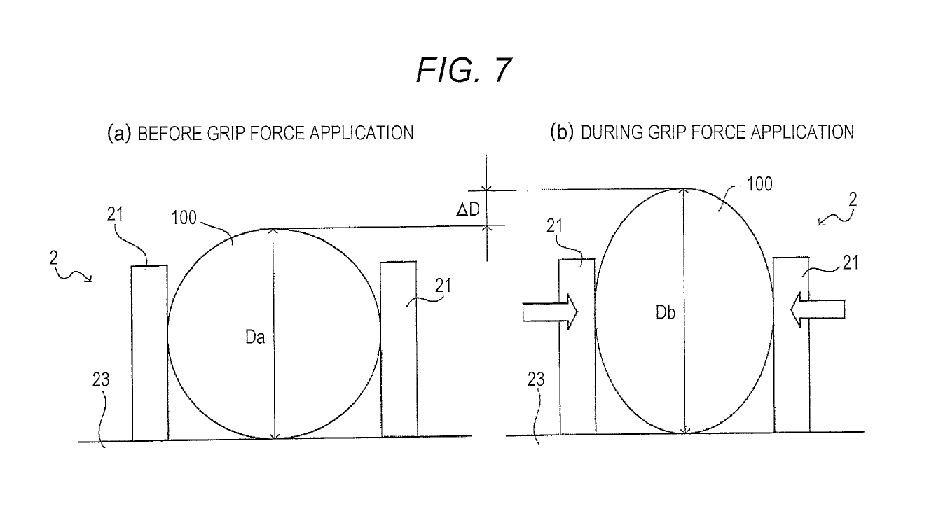

Due to the convenience of the grip orientation of the gripping target object 100 and the gripping direction of the gripper 2 in a production machine, there are cases where the deformation amount of the gripping target object 100 tends to be detected to be large in a direction different from the gripping direction. For example, as shown in FIG. 7 corresponding to FIG. 3, depending on the gripping target object 100, there are cases where the gripping target object 100 has gripping characteristics in which the deformation amount tends to be detected to be large in the vertical direction in the figure orthogonal to the gripping direction. Correspondingly, the deformation amount may be detected in a direction different from the gripping direction in which the camera 3 and the image processing apparatus 4 apply the test grip force (for example, a direction from above to below in the figure or a direction orthogonal to the plane of the figure; not shown). As a result, it is possible to improve the detection accuracy (setting precision of the operation grip force) of the effective deformation amount with respect to the gripping target object 100 having gripping characteristics that tend to be deformed particularly in a direction different from the gripping direction.

When the optical sensor is the camera 3, the deformation amount may be detected with respect to a projected area of the gripping target object 100 in the imaging field of view. In this case, it is possible to improve the detection accuracy (setting precision of the operation grip force) of the particularly effective deformation amount with respect to the gripping target object 100 having gripping characteristics in which the projected area (or surface area) tends to change corresponding to application of the test grip force.

In the present embodiment, in particular, the actuator which directly grips the gripping target object 100 is the gripper 2 driven by the motor 22, so that geometric and electrical analysis of the grip force with respect to the gripping target object 100 is facilitated.

Further, in the present embodiment, in particular, the servo amplifier 6 which drives and controls the motor 22 by the torque control based on the test grip force or the operation grip force is provided, whereby electrical control of the grip force applied to the gripping target object 100 by the gripper 2 is facilitated. The motor 22 which drives the gripper 2 is not limited to the rotary type, and a direct acting type linear motor may be applied. In this case, the operation command output from the controller 5 to the servo amplifier 6 is a thrust command equivalent to the grip force, and the servo amplifier 6 controls thrust of the linear motor to cause the gripper 2 to output the grip force.

In the above embodiment, an object having flexibility similar to that of foods and ingredients is used as a gripping target object, but the present invention is not limited to this. For example, it is also suitable to apply an article (structure), which is made of glass, plastic, or the like and may be broken depending on the magnitude and direction of the grip force to be applied, as the gripping target object.

### 7. MODIFIED EXAMPLES

The disclosed embodiment is not limited to that described above, but may be modified in various forms so long as it does not deviate from the scope and the technical concept. Such modified examples will be described below.

### Example 1

### Case of Using Three-Finger Gripper

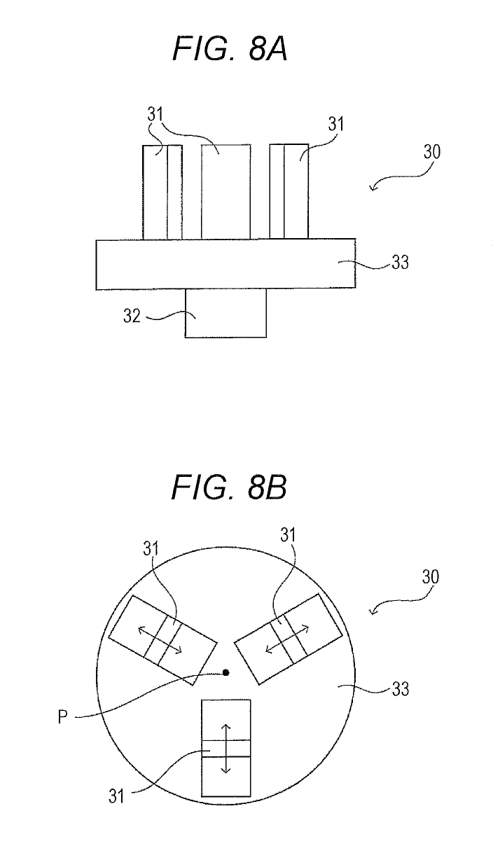

In the above embodiment, the case of using the gripper 2 which grips the gripping target object 100 so as to hold the gripping target object 100 between the two gripping claws 21 arranged in parallel has been described, but the present invention is not limited to this. Alternatively, as shown in FIGS. 8A and 8B, a three-finger gripper 30 having three gripping claws 31 arranged at equal intervals on the circumference may be used. FIG. 8A shows an appearance of the entire three-finger gripper 30 as viewed from the side. FIG. 8B shows the appearance of the entire three-finger gripper 30 as viewed from above. In FIGS. 8A and 8B, the three-finger gripper 30 has a motor 32, a gripper body 33, and the three gripping claws 31.

The motor 32 uses a rotary motor and is fixed to an end surface of the gripper body 33 (the lower side in FIG. 8A) which is a substantially columnar casing. A shaft rotation output of the motor 32 is converted into a linear motion output of the three gripping claws 31 via a drive mechanism constituted of a pinion gear, a driven gear, a rack gear, a linear guide and the like (not shown) provided inside the gripper body 33. By switching the forward rotation and the reverse rotation of the motor 32, the three gripping claws 31 whose contact surfaces are directed to a center point P of the gripper body 33 are operated so as to switch between approaching operation in which the three gripping claws 31 are approaching the center point P and separating operation. The grip force between the three gripping claws 31 is controlled by controlling the torque of the motor 32. In the functioning as described above, the three-finger gripper 30 can perform radial gripping operation and releasing operation with respect to the gripping target object 100 disposed between the three gripping claws 31.

Also in the three-finger gripper 30, it is desirable that the three-finger gripper 30 be configured to be capable of outputting relatively low grip force with high accuracy. Specifically, it is preferable to use a servo motor, which can output and control a low torque with high accuracy, as the motor 32. In order to smoothly and linearly move the gripping claw 31, it is preferable to use a pinion gear and a rack gear capable of being meshed with rotation with low friction and a linear guide mechanism of low friction. Further, it is preferable to use the gripping claw 31 whose shape, material, and configuration that can stably grip the gripping target object 100 even with relatively low grip force by, for example, securing a sufficient contact area with respect to the gripping target object 100. Furthermore, it is preferable to properly consider design of a mechanical configuration in consideration of, for example, a position of a center of gravity of the entire three-finger gripper 30 and assembly and adjustment of each component.

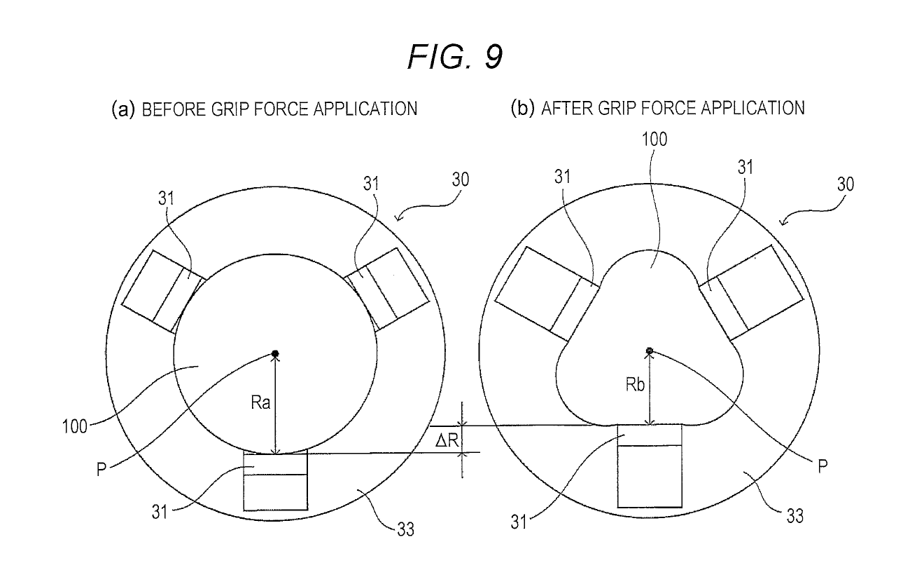

When the three-finger gripper 30 thus configured is used, as shown in FIG. 9 corresponding to FIG. 3, for example, the deformation amount may be detected based on a deviation dimension ΔR of the gripping target object 100 from the center point P of the gripper body 33 to a contact surface of the gripping claw 31 along the gripping direction of each of the gripping claws 31. For this purpose, it is desirable that the camera 3 be disposed on the center axis of the gripper body 33 (on the near side of the figure). The three-finger gripper 30 as described above is suitable for stably gripping the gripping target object 100 in a substantially triangular prism shape or a substantially rotating body shape such as rice ball, ohagi (a type of Japanese bean cake), or egg.

### Example 2

### Case of Using Distance Sensor for Optical Sensor

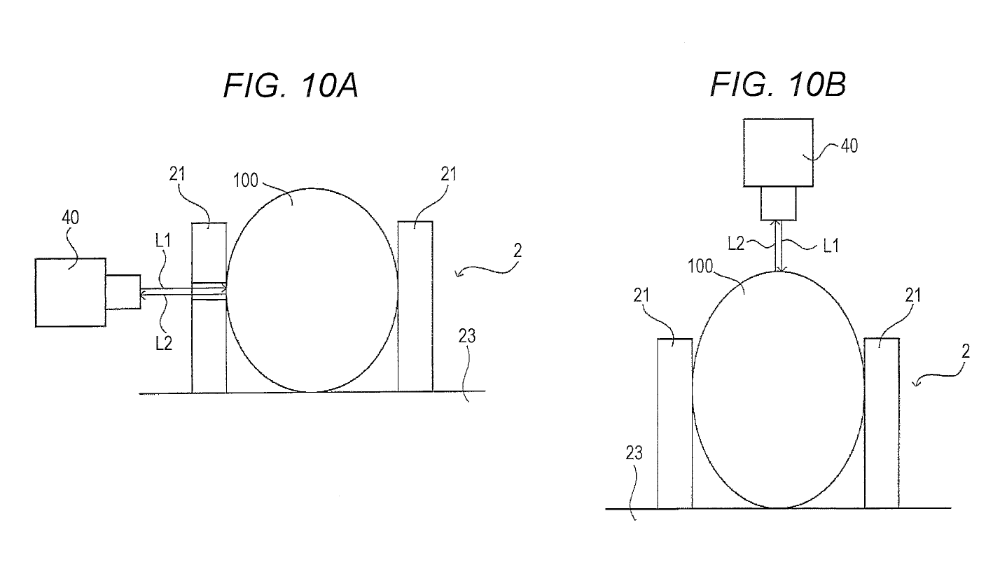

In the above embodiment, the case of using the camera 3 as the optical sensor for detecting the deformation amount of the gripping target object 100 has been described, but the present invention is not limited to this. Alternatively, a distance sensor may be used instead of the camera 3 to detect the deformation amount of the gripping target object 100. As shown in FIGS. 10A and 10B, a distance sensor 40 is an optical sensor which measures a distance to the surface of the gripping target object 100 (the position of the surface) based on a time difference from when laser beam L1 is projected toward the gripping target object 100 to when reflected light L2 from the surface of the gripping target object 100 is received. Even in this case, the deformation amount can be detected in a direction corresponding to the deformation directivity of the gripping target object 100. For example, the deformation amount can be detected in the direction equal to the gripping direction of the gripper 2 as shown in FIG. 10A, or the deformation amount can be detected in a direction different from the gripping direction of the gripper 2 as shown in FIG. 10B. Even in the case of using the distance sensor 40, when there is no individual difference in the shape and size of the gripping target object 100, and the gripping position of the gripping target object 100 is always fixed, the deformation amount of the gripping target object 100 can be detected, similarly to the case of using the camera 3.

In this modified example, by using the relatively inexpensive distance sensor 40 as an optical sensor, the deformation amount can be detected with a configuration which is simpler than the case of using the camera 3 and in which the manufacturing cost is suppressed.

In this modified example, in particular, the distance sensor 40 detects the deformation amount by displacement of the surface of the gripping target object 100, whereby the processing load on the image processing apparatus 4 is reduced, so that simple and rapid detection of the deformation amount becomes possible.

### Example 3

### Case of Estimating Grip Force Based on Detected Deformation Amount

In the above embodiment, the camera 3 and the image processing apparatus 4 have been removed from the system on the assumption that the detection of the deformation amount is unnecessary during the actual operation after once setting a suitable operation grip force. However, even during the actual operation, the deformation amount of the gripping target object 100 is detected by the camera 3 and the image processing apparatus 4, and the grip force (estimated grip force) applied to the gripping target object 100 at that point may be estimated based on the deformation amount.

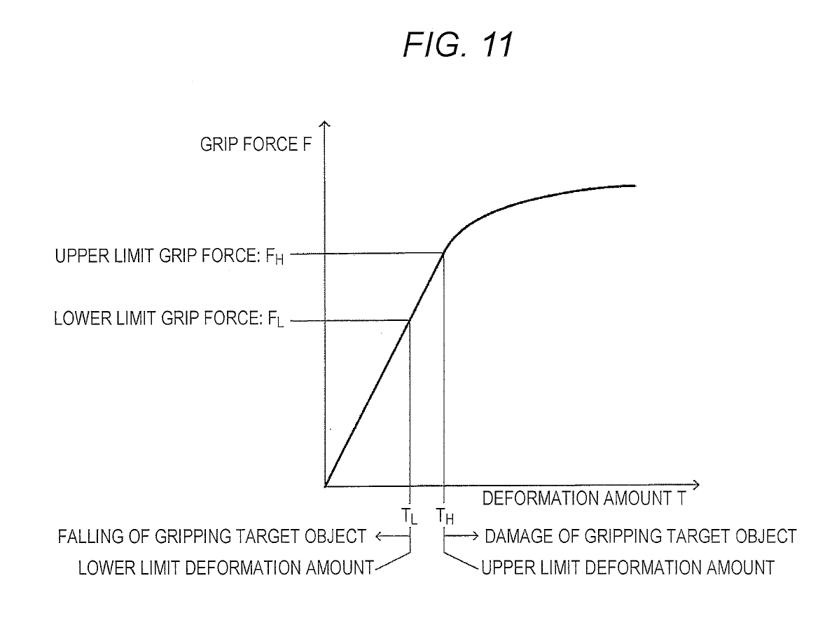

In this case, deformation characteristics as shown in FIG. 11 can be obtained by replacing the abscissa axis coordinates and the ordinate axis coordinates with respect to the gripping characteristics of FIG. 4 already obtained for the same gripping target object 100 by the grip force setting processing. That is, in the graph of the deformation characteristics shown in FIG. 11, the horizontal axis corresponds to the deformation amount which is a detection value, and the vertical axis corresponds to the grip force which is an estimation value. Based on the deformation characteristics, the controller 5 can estimate the grip force corresponding to the deformation amount detected from the image processing apparatus 4. In the deformation characteristics, a maximum upper limit deformation amount that the gripper 2 does not damage the gripping target object 100 and a minimum lower limit deformation amount that the gripper 2 can lift the gripping target object 100 are also known. Setting the operation deformation amount between the upper limit deformation amount and the lower limit deformation amount enables more suitable and reliable setting in order to execute the gripping operation and the transfer operation. In this modified example, the camera 3 and the image processing apparatus 4 correspond to a detector recited in the claims. The controller 5 corresponds to circuitry recited in the claims. The whole system corresponds to a grip force estimating system recited in the claims.

As described above, the grip force estimating system of the present modified example has the camera 3, the image processing apparatus 4, and the controller 5. The camera 3 and the image processing apparatus 4 detect the deformation amount of the gripping target object 100 when the gripper 2 grips the gripping target object 100 having predetermined deformation characteristics. The controller 5 estimates the grip force applied when the gripper 2 grips the gripping target object 100 based on the deformation amount. This makes it possible to detect a sanitary and highly durable grip force by non-contact as compared with a case where the grip force is detected by providing a pressure contact sensor on the gripping claw 21 of the gripper 2.

Further, for example, depending on the specifications of the controller 5 and the servo amplifier 6, torque control (thrust control, current control) cannot be performed, and only position control and speed control are possible in some cases. On the other hand, in the present modified example, the controller 5 estimates the grip force applied to the gripping target object 100 at that point based on the deformation amount detected by the camera 3 and the image processing apparatus 4, and can perform position control or speed control so as to feed back the grip force estimation value to match the grip force with the operation grip force.

A relationship between the grip force and the deformation amount depending on the type of the gripping target object 100, that is, the gripping characteristics and the deformation characteristics described above may be acquired by so-called machine learning in which a pair of the corresponding grip force and deformation amount is used as teacher data (Bayesian network, support vector machine, deep learning, etc.). In this case, by using the optical sensor as the camera 3, the deformation amount can be detected as a shape change amount of the entire gripping target object 100, not limited to a dimensional change based on specific deformation directivity.

### 8. EXEMPLARY HARDWARE CONFIGURATION OF IMAGE PROCESSING APPARATUS AND CONTROLLER

Next, an exemplary hardware configuration of the controller 5 and the image processing apparatus 4 will be described with reference to FIG. 12. It is assumed that the controller 5 and the image processing apparatus 4 have the same hardware configuration shown in FIG. 12, respectively.

As shown in FIG. 12, the image processing apparatus 4 and the controller 5 have, for example, a CPU 901, a ROM 903, a RAM 905, a dedicated integrated circuit 907 constructed for specific use such as an ASIC or an FPGA, an input device 913, an output device 915, a storage device 917, a drive 919, a connection port 921, and a communication device 923. These constituent elements are mutually connected via a bus 909 and an I/O interface 911 such that signals can be transferred.

The program can be recorded in the ROM 903, the RAM 905, and the storage device 917, for example.

The program can also temporarily or permanently be recorded in a removable recording medium 925 such as magnetic disks including flexible disks, various optical disks including CDs, MO disks, and DVDs, and semiconductor memories. The removable recording medium 925 as described above can be provided as so-called packaged software. In this case, the program recorded in the removable recording medium 925 may be read by the drive 919 and recorded in the storage device 917 through the I/O interface 911, the bus 909, etc.

The program may be recorded in, for example, a download site, another computer, or another storage device (not shown). In this case, the program is transferred through a network NW such as a LAN and the Internet, and the communication device 923 receives this program. The program received by the communication device 923 may be recorded in the storage device 917 through the I/O interface 911, the bus 909, etc.

The program may be recorded in appropriate externally-connected equipment 927, for example. In this case, the program may be transferred through the appropriate connection port 921 and recorded in the storage device 917 through the I/O interface 911, the bus 909, etc.

Then, the CPU 901 executes various processes in accordance with the program recorded in the storage device 917 to implement the processes of the detector, the circuitry, recited in the claims. In this case, the CPU 901 may directly read and execute the program from the storage device 917 or may execute the program once loaded in the RAM 905. In the case that the CPU 901 receives the program through, for example, the communication device 923, the drive 919, or the connection port 921, the CPU 901 may directly execute the received program without recording in the storage device 917.

The CPU 901 may execute various processes based on a signal or information input from the input device 913 such as a mouse, a keyboard, and a microphone (not shown) as needed.

The CPU 901 may output a result of execution of the process from the output device 915 such as a display device and a sound output device, for example, and the CPU 901 may transmit this process result through the communication device 923 or the connection port 921 as needed or may record the process result into the storage device 917 or the removable recording medium 925.

It is noted that the term “vertical” used in the above description is not used in the exact meanings thereof. Specifically, this term “vertical” allows tolerances and errors in design and manufacturing and has meanings of “approximately vertical”.

It is noted that the term “parallel” used in the above description is not used in the exact meanings thereof. Specifically, this term “parallel” allows tolerances and errors in design and manufacturing and has meanings of “approximately parallel”.

It is noted that the term “equal” used in the above description is not used in the exact meanings thereof. Specifically, this term “equal” allows tolerances and errors in design and manufacturing and has meanings of “approximately equal”.

Techniques by the embodiment and each modified example may be appropriately combined and utilized in addition to the examples having already described above.

Although exemplification is not performed one by one, the embodiment and each modified example are carried out by various changes being applied thereto without departing from the technical idea of the present disclosure.

Obviously, numerous modifications and variations of the present invention are possible in light of the above teachings. It is therefore to be understood that within the scope of the appended claims, the invention may be practiced otherwise than as specifically described herein.

What is claimed is:

1. A grip force setting system comprising:
a gripper to grip a gripping target object;
a detector to detect a deformation amount of the gripping target object in a state in which the gripper grips the gripping target object with a test grip force; and
circuitry to determine an operation grip force of the gripper based on a specific deformation characteristic value calculated based on a ratio of the deformation amount to the test grip force.

2. The grip force setting system according to claim 1, wherein the circuitry is configured to determine the operation grip force within a linear proportional region of the test grip force and the deformation amount at which the specific deformation characteristic value is substantially constant.

3. The grip force setting system according to claim 2, wherein the circuitry is configured to determine a maximum upper limit grip force at which the gripper does not damage the gripping target object and a minimum lower limit grip force which allows the gripper to lift the gripping target object and determine the operation grip force between the maximum upper limit grip force and the minimum lower limit grip force.

4. The grip force setting system according to claim 1, wherein the detector comprises an optical sensor which is configured to detect a shape of the gripping target object by an optical method.

5. The grip force setting system according to claim 4, wherein the optical sensor comprises a camera which is configured to capture an entire shape of the gripping target object.

6. The grip force setting system according to claim 5, wherein the detector is configured to detect the deformation amount with a ratio of an absolute shape change amount to an entire size of the gripping target object.

7. The grip force setting system according to claim 4, wherein the optical sensor comprises a distance sensor to measure a position of a surface of the gripping target object.

8. The grip force setting system according to claim 7, wherein the detector is configured to detect the deformation amount with displacement of the surface of the gripping target object.

9. The grip force setting system according to claim 1, wherein the detector is configured to detect the deformation amount in a direction different from a gripping direction to which the test grip force is applied.

10. The grip force setting system according to claim 1, wherein the detector is configured to detect the deformation amount in a direction along a gripping direction to which the test grip force is applied.

11. The grip force setting system according to claim 1, wherein the gripper is configured to be driven by a motor.

12. The grip force setting system according to claim 11, further comprising:
a motor controller to control the motor via torque control or thrust control based on the test grip force or the operation grip force.

13. A grip force setting method comprising:
gripping a gripping target object via a gripper;
detecting a deformation amount of the gripping target object in a state in which the gripper grips the gripping target object with a test grip force; and
determining an operation grip force of the gripper based on a specific deformation characteristic value calculated based on a ratio of the deformation amount to the test grip force.

14. A grip force estimating system comprising:
a detector to detect a deformation amount of a gripping target object in a state in which a gripper grips the gripping target object with a test grip force; and
circuitry to estimate an estimated grip force based on the deformation amount when the gripper grips the gripping target object.
